(19) United States
(12) Patent Application Publication
(10) Pub. No.: US 2022/0177275 A1
(43) Pub. Date: Jun. 9, 2022

(54) ELEVATOR CAR ENCLOSURE

(71) Applicant: Otis Elevator Company, Farmington, CT (US)

(72) Inventors: Andres Monzon Simon, Leganes (ES); Mario Sanz Abia, Valladolid (ES); Ariana Marco Foruny, Madrid (ES); Manuel Garcia Canales, Madrid (ES)

(21) Appl. No.: 17/401,936

(22) Filed: Aug. 13, 2021

(30) Foreign Application Priority Data
Dec. 3, 2020 (EP) 20383050.0

(51) Int. Cl. B66B 11/02

(52) U.S. Cl. CPC B66B 11/0253; B66B 11/0206

(57) ABSTRACT

An elevator car enclosure (106) which defines a volume (142) for receiving a load to be transported, wherein the elevator car enclosure (106) is formed from a single moulded body.

This application claims priority to European Patent Application No. 20383050.0, filed Dec. 3, 2020, and all the benefits accruing therefrom under 35 U.S.C. § 119, the contents of which in its entirety are herein incorporated by reference.

### TECHNICAL FIELD

This disclosure relates to an elevator car enclosure and a method of assembling an elevator car.

### BACKGROUND

Elevator cars often comprise a metal support frame to which a number of sheet metal panels are attached. The sheet metal panels typically define an enclosure in which passengers or goods may be transported. Such elevator cars are suitable for many applications; however, they are relatively expensive to produce and often relatively heavy due to the materials from which they are made. As a result, such elevator cars typically require specialised equipment to transport and install the elevator cars. Additionally, due to the materials from which the elevator cars are made, the elevator cars are relatively expensive to manufacture. Further, assembly of the elevator cars, which often occurs on site, can be time consuming.

It would be advantageous to provide a means which addresses or mitigates at least some of the problems outlined above.

### SUMMARY

In accordance with a first aspect, the present disclosure provides an elevator car enclosure which defines a volume for receiving a load to be transported, wherein the elevator car enclosure is formed from a single moulded body.

Accordingly, as will be appreciated, forming the elevator car enclosure from a single moulded body may reduce the cost of manufacture of the elevator car enclosure when compared to prior art enclosures which are defined by multiple panels of sheet metal. Additionally, manufacture of the elevator car may be simplified when compared to prior art techniques as it may be easier to produce an elevator car enclosure from a single moulded body. Further, the overall assembly and installation time for an elevator car assembly may be reduced as the single moulded body of the elevator car enclosure may reduce the amount of on-site assembly which is required. The load to be transported may comprise passenger(s) and/or goods and/or any other object which may need to be transported.

The single moulded body may comprise any suitable material that can be moulded to define the elevator car enclosure. In a set of examples, the single moulded body comprises a polymeric material. In other words, the single moulded body is made from a polymeric material. The polymeric material may be any suitable material. For example, the polymeric material may comprise plastic, e.g. high density polyethylene (HDPE). The polymeric material may also comprise at least one of: polyamide, polyvinylchloride, high-impact polystyrene, polycarbonate, polyester and polypropylene. The use of a polymeric material may advantageously minimise the mass of the elevator car enclosure, at least when compared to prior art enclosures which are formed from metal panels. This may mean that the elevator car enclosure is easier to transport and also easier to manoeuvre at an elevator installation site. This may advantageously minimise the number of personnel and/or specialist installation equipment required to install the elevator car enclosure. The single moulded body may be moulded by any suitable technique. For example, the single moulded body may be blow moulded and/or injection moulded.

The single moulded body may also comprise other materials in addition to the polymeric material. For example, other materials may be embedded within the polymeric material. The single moulded body may, for example, comprise other materials which improve the structural rigidity of the elevator car enclosure. As such, the single moulded body may comprise integrally formed structural elements. For example, the single moulded body may comprise a plurality of reinforcing fibres arranged to reinforce at least portions of the single moulded body. The reinforcing fibres may comprise glass fibres, Kevlar fibres, carbon fibres or any other suitable material. The integrally formed structural elements may be positioned in specific portions of the single moulded body where reinforcement is required, e.g. on a floor thereof. Other materials may, for example, include fire prevention additives which are flame resistant and thus act to inhibit fire transmission within the elevator car enclosure.

Elevator cars are typically relatively large, and thus the elevator car enclosure may thus define a relatively large volume. In a set of examples, the elevator car enclosure has a variable volume. The ability to vary, i.e. adjust, the volume of the elevator car enclosure may advantageously mean that the volume of the elevator car enclosure can be minimised for transportation of the elevator car enclosure to an elevator installation site, and subsequently be expanded once on site. This may mean that the elevator car enclosure can be transported to an installation site, and maneuvered on site, more easily. Further, the ability to change the volume of the elevator car enclosure may advantageously mean that the volume, i.e. the size, of the elevator car enclosure can be adapted to suit a particular elevator installation. For example, the volume may be increased for an elevator installation which is designed to incorporate a larger elevator car. Accordingly, the ability to vary the volume of the elevator car enclosure may mean that a single elevator car enclosure can be manufactured which is suitable for a number of different elevator installations. This may minimise the tooling costs required to manufacture elevator car enclosures suitable for a plurality of different elevator installations.

In a further set of examples, the elevator car enclosure is configured to be capable of expanding from a contracted configuration, in which the elevator car enclosure defines a first volume, into an expanded configuration in which the elevator car enclosure defines a second, larger volume. As will be appreciated, the elevator car enclosure may be transported and maneuvered in the contracted configuration, and only expanded into the expanded configuration once at an elevator installation site. Of course, the elevator car enclosure may also be contracted from the expanded configuration into the contracted configuration. The elevator car enclosure may be capable of expanding into at least one further expanded configuration. As such, the size of the elevator car enclosure may be expanded to suit a size of the elevator installation in which it is installed.

The variable volume of the elevator car enclosure, including the ability to expand and contract, may be achieved via any suitable means. For example, walls of the elevator car enclosure may facilitate expansion and contraction of the elevator car enclosure. In a set of examples, the elevator car enclosure comprises a plurality of walls which define the volume and wherein at least one of the plurality of walls comprises a corrugated structure configured to allow the elevator car enclosure to expand from the contracted configuration into the expanded configuration. A corrugated structure may provide a simple and convenient means to facilitate changing the volume of the elevator car enclosure. The corrugated structure may have any suitable form that permits expansion and/or contraction of the elevator car enclosure. The corrugated structure may, for example, have a waved or castellated structure. The corrugated structure may comprise a series of folds which define a plurality of ridges and grooves. In examples wherein multiple of the plurality of walls comprise a corrugated structure, the corrugated structure may effectively define a bellowed structure. The plurality of walls may include side walls of the elevator car enclosure, as well as the walls which define the ceiling and floor if included.

In a set of examples, the elevator car enclosure is configured to be capable of expanding in a horizontal plane and/or a vertical plane. The ability to expand in a horizontal plane may allow the elevator car enclosure to be expanded to suit the dimensions of a particular elevator installation. Expansion in a horizontal plane may increase a floor space of the elevator car enclosure. A single elevator car enclosure may thus be suitable for a range of different sized elevator installations. Additionally, the ability to expand the elevator car enclosure in the horizontal plane may make assembly of the elevator car, which comprises the elevator car enclosure, easier as the elevator car enclosure can quickly and easily be adjusted to the desired shape and size. In a similar manner, the ability to expand in the vertical plane may advantageously mean that a height of the elevator car enclosure can be adjusted to a desired dimension.

An elevator car enclosure which is configured to be capable of expanding in both the horizontal and vertical planes may mean that in a contracted configuration the elevator car enclosure occupies a minimum possible space. As with earlier examples, this may make transportation and maneuvering of the elevator car enclosure easier. The ability to expand in both the vertical and horizontal direction may also provide the maximum degree of variability in the volume of the elevator car enclosure, and thus the elevator car enclosure may be suitable for a larger range of different elevator installations.

When in the contracted configuration, the elevator car enclosure may tend to expand towards the expanded configuration. This may, for example, be due to an inherent resilient bias provided in the material of the single moulded body. For example, it may be due to a resilient bias provided by corrugations which permit the expansion of the elevator car enclosure. Expansion of the elevator car enclosure prior to installation at an elevator installation site may not be desirable. Thus, in a set of examples, the elevator car enclosure further comprises at least one support member arranged to hold the elevator car enclosure in the contracted configuration. The support member may be separate from the single moulded body, and thus be provided by a separate part. The support member may act to hold the elevator car enclosure in the contracted configuration until expansion of the elevator car enclosure is required. This may advantageously mean that the elevator car enclosure can be transported to, and enclosure is on site and ready for installation, the at least one support member may be removed, or released, and the elevator car enclosure may be expanded into the expanded configuration. However, as will be appreciated, it may not always be necessary to hold the elevator car enclosure in the contracted configuration. For example, in examples wherein the elevator car enclosure is configured to expand in a vertical direction, the weight of the elevator car enclosure itself may be sufficient to hold the elevator car enclosure in the contracted configuration.

When in the expanded configuration, the elevator car enclosure may be stable, i.e. it may remain in the expanded configuration, and thus there may not be any need to hold the elevator car enclosure in the expanded configuration. However, in some examples, the elevator car enclosure may tend to contract towards the contracted configuration. This may, for example, be due to gravity or other forces acting on the elevator car enclosure. Thus, in a set of examples, the elevator enclosure further comprises at least one support member arranged to hold the elevator car enclosure in the expanded configuration. As with the support member discussed above, the at least one support member may be a separate part to the single moulded body. The at least one support member may hold the elevator car enclosure in the expanded configuration and prevent it from moving towards the contracted configuration. This may help to ensure that in use the elevator car enclosure has fixed dimensions and does not collapse. The at least one support member may be the same support member as the support member discussed above for holding the elevator car enclosure in the contracted configuration or it may comprise a further support member.

The at least one support member of either of the examples described above may be any support member that is capable of holding the elevator car enclosure in the respective configurations. For example, the at least one support member may comprise an at least partially threaded rod which engages with a corresponding threaded nut, or other suitable locking member. The at least partially threaded rod may be inserted through the elevator car enclosure and the threaded nuts may be secured in an appropriate manner to hold the elevator car enclosure in the respective configurations.

As discussed above, the elevator car enclosure may be easier to install when compared to prior art elevator cars. In a further set of examples, the single moulded body comprises at least one integrally formed mounting feature for mounting an elevator car component to the elevator car enclosure. Integrally moulding a mounting feature of this type, i.e. forming the mounting feature from the same single moulded body, may further simplify manufacture of the elevator car enclosure as well as assembly of an elevator car comprising the elevator car enclosure. As will be appreciated, elevator car components may quickly and easily be mounted to the at least one integrally formed mounting feature and thus the assembly of the elevator car may be simplified. Integrally forming mounting features in this manner may also help to ensure that the elevator car components are mounted at the proper positions in the elevator car enclosure.

The at least one integrally formed mounting feature may be suitable for mounting any suitable elevator car component. For example, the at least one integrally formed mounting feature may comprise a support frame mounting feature for mounting a support frame to the elevator car enclosure. In addition or alternatively, the at least one integrally formed mounting feature may comprise an integrally formed conduit for mounting at least one electrical cable within the elevator car enclosure. Further, the at least one integrally formed mounting feature may comprise a car operation panel mounting feature for mounting a car operation panel in the elevator car enclosure. For example, the car operation panel mounting feature may comprise a recessed portion in a wall of the elevator car enclosure.

In examples comprising support members as discussed above, the elevator car enclosure may comprise integrally formed mounting features for the support members. For example, the elevator car enclosure may comprise integrally formed aperture(s) through which the at least one support member may extend.

Elevator cars typically comprise a door assembly which controls access to the volume within the elevator car. In another set of examples, the single moulded body comprises an opening for allowing the passage of a load into the volume defined by the single moulded body. The opening may, for example, be door-shaped. Integrally forming the opening within the single moulded body may, similarly to the integrally formed mounting features discussed above, further simplify the assembly of an elevator car comprising the elevator car enclosure. For example, with the opening already present in the elevator car enclosure, an installer may simply install an elevator car door to the opening and door functionality may be provided. Including an opening in this manner may also ensure that the opening has the precise dimensions required and is thus capable of receiving the elevator car door. In some examples, the single moulded body may comprise a further opening so that the elevator car enclosure can allow ingress and egress through multiple openings. The opening and further opening may be on opposing sides of the elevator car enclosure.

The elevator car enclosure may have any shape that defines a volume suitable for transporting a load. The shape of the elevator car enclosure may at least partially depend on the shape required for a particular elevator installation. In a set of examples, the single moulded body comprises a plurality of side walls which at least partially define the volume of the elevator car enclosure. For example, the plurality of side walls may comprise four walls arranged to at least partially define a cuboid-shaped volume. In embodiments comprising an opening, the opening may be present in one of the plurality of side walls.

In another set of examples, the single moulded body comprises a floor and/or a ceiling which at least partially define the volume of the elevator car enclosure. Accordingly, the side walls, floor and ceiling may together define the volume of the elevator car enclosure.

The elevator car enclosure may be capable of supporting a load such as passengers and/or goods which are to be transported by an elevator car. In some examples, the elevator car enclosure may be capable of supporting a load which comprises a plurality of objects, e.g. a plurality of passengers. The elevator car enclosure may be capable of supporting any suitable load. In a set of examples, the single moulded body is capable of supporting a mass of up to 1000 kg, e.g. up to 750 kg, e.g. up to 650 kg. The elevator car enclosure may thus be capable of supporting a plurality of passengers and/or a variety of different goods. Advantageously, this may mean that the elevator car enclosure is suitable for a variety of different elevator installations.

In some examples, a first portion of single moulded body may have a first thickness, and a second portion may have a second, different thickness. For example, the floor, i.e. a first portion, of the elevator car enclosure may be thicker than the side walls, i.e. a second portion, of the elevator car enclosure. The increased thickness of the floor, at least compared to the side walls, may ensure that that the floor is capable of supporting a load thereon, whilst having the side walls thinner may help to minimise the weight of the elevator car enclosure. The relative thicknesses of the elevator car enclosure may be integrally formed as part of the moulding of the elevator car enclosure.

According to another aspect of the present disclosure there is provided an elevator car comprising: one or more of the elevator car enclosures according to any of the examples described above; and a support frame configured to support the one or more elevator car enclosures.

The support frame may be any frame that is capable of supporting the elevator car. For example, the support frame may comprise a cantilever support frame.

In a further set of examples, the elevator car comprises at least two elevator car enclosures. Such an elevator car may be considered to have a modular construction with each of the elevator car enclosures being a module. Each of the elevator car enclosures may comprise a respective opening which is aligned with an opening in an adjacent elevator car enclosure so as to allow a load to pass through from one elevator car enclosure to the next. When provided together, the volume of each of the at least two elevator car enclosures may together provide a single, combined, larger volume. An elevator car comprising at least two elevator car enclosures arranged in this manner may be capable of transporting a load having a greater size and/or weight.

In examples comprising at least two elevator car enclosures, each of the elevator car enclosures may be coupled to the other elevator car enclosures by any suitable arrangement. For example, the support frame may act to hold the elevator car enclosures together in a coupled manner. In another set of examples, there may be a coupling arrangement which acts to couple each of the elevator car enclosures to an adjacent elevator car enclosure. For example, each of the plurality of elevator car enclosures may be bolted together.

In another set of examples, at least one of the one or more elevator car enclosures comprises an opening and the elevator car comprises a door arranged to selectively close the opening.

As will be appreciated by those skilled in the art, assembly and installation of the elevator car including an elevator car enclosure described above will be quite different to the installation of prior art elevator cars. Therefore, according to a further aspect of the present disclosure there is provided a method of assembling an elevator car comprising a support frame and an elevator car enclosure which defines a volume and which is formed from a single moulded body, wherein the method comprises attaching the support frame to the elevator car enclosure to form the elevator car.

The elevator car enclosure may comprise any of the features of the elevator car enclosure described above with reference to the first aspect of the present disclosure. In a set of examples, the elevator car enclosure has a variable volume and wherein the method comprises changing the volume of the elevator car enclosure to a desired volume at an elevator installation site.

The elevator car enclosure may, for example, be expanded from a contracted configuration into an expanded configuration prior to attaching the support frame to the elevator car enclosure.

In another set of examples, the elevator car enclosure comprises at least one integrally formed mounting feature, and wherein the method further comprises mounting an elevator car component to the at least one integrally formed mounting feature.

In another set of examples, the elevator car enclosure comprises at least one support member configured to hold the elevator car enclosure in a contracted configuration and wherein the method further comprises removing or releasing the at least one support member to allow the elevator car enclosure to be expanded into an expanded configuration.

In another set of examples, the elevator car enclosure comprises at least one support member configured to hold the elevator car enclosure in an expanded configuration and wherein the method further comprises configuring the at least one support member to hold the elevator car enclosure in an expanded configuration.

In another set of examples, the elevator car enclosure comprises at least one opening to allow a load to pass into the volume, and wherein the method comprises securing a door assembly to the opening.

In another set of examples, the method comprises attaching at least one further elevator car enclosure to the support frame. The at least one further elevator car enclosure may comprise any of the features of the elevator car enclosure according to examples of the first aspect of the present disclosure described above. Any of the steps described above with respect to the elevator car enclosure may also be performed on the further elevator car enclosure. In a further set of examples, the method comprises aligning an opening on the elevator car enclosure with an opening on the further elevator car enclosure.

### BRIEF DESCRIPTION OF THE DRAWINGS

Certain examples of the present disclosure will now be described with reference to the accompanying drawings, in which:

FIG. 1 is a schematic illustration of an elevator system comprising an elevator car enclosure in accordance with an example of the present disclosure;

FIG. 2 is a perspective view of the elevator car enclosure shown in FIG. 1 in an expanded configuration;

FIG. 3 is a perspective view of the elevator car enclosure shown in FIG. 1 in a contracted configuration;

FIG. 4 is a side view of the elevator car enclosure shown in FIG. 1 in a contracted configuration;

FIG. 5 is a side view of the elevator car enclosure shown in FIG. 1 in an expanded configuration;

FIG. 6 is an internal view of the elevator car enclosure shown in FIG. 1 illustrating a car operating panel mounting feature;

FIG. 7 is a view illustrating assembly of the elevator car shown in FIG. 1;

FIG. 8 is a perspective view of the fully assembled elevator car;

FIG. 9 is a side view of the fully assembled elevator car shown in FIG. 8;

FIG. 10 is a front view of the elevator car shown in FIG. 8 with the elevator car doors removed;

FIG. 11 is a perspective view of another elevator car enclosure in accordance with another example of the present disclosure;

FIG. 12 is a side view of the elevator car enclosure shown in FIG. 11 in a contracted configuration;

FIG. 13 is a side view of the elevator car enclosure shown in FIG. 11 in an expanded configuration;

FIGS. 14A-14B are perspective views illustrating the mounting of an elevator car enclosure on a cantilever support frame;

FIG. 15A-15B show perspective views illustrating an elevator car in accordance with an example of the present disclosure which comprises two elevator car enclosures; and

FIG. 16 shows a perspective view of an elevator car which comprises two elevator car enclosures and two separate suspension elements.

### DETAILED DESCRIPTION

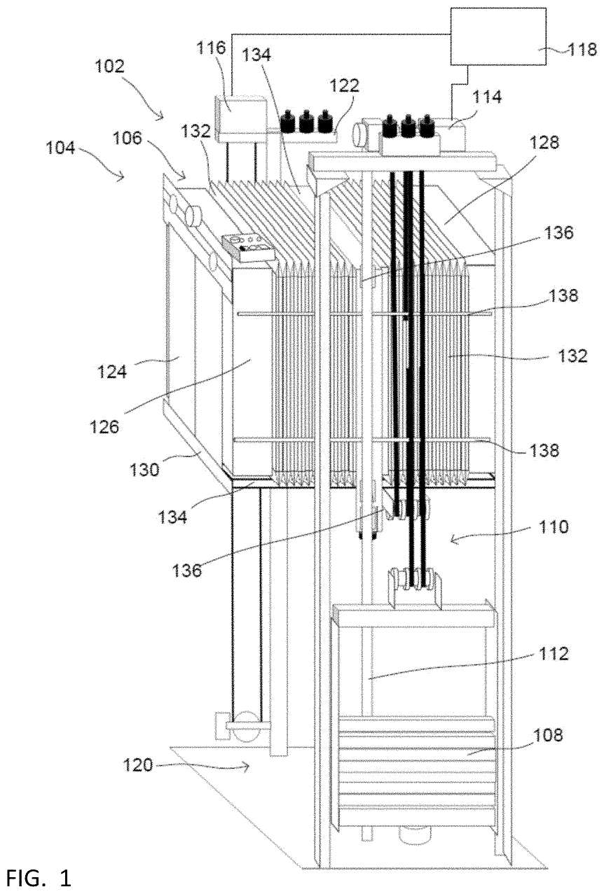

FIG. 1 is a perspective view of an elevator system 102 including an elevator car 104 which comprises an elevator car enclosure 106 in accordance with an example of the present disclosure. The elevator system 102 further comprises a counterweight 108, a suspension element 110, a guide rail 112, an elevator machine 114, an encoder 116, and a controller 118. The elevator car 104 and counterweight 108 are connected to each other by the suspension element 110. The suspension element 110 may include or be configured as, for example, ropes, steel cables, and/or coated-steel belts. The counterweight 108 is configured to balance a load of the elevator car 104 and is configured to facilitate movement of the elevator car 104 concurrently and in an opposite direction with respect to the counterweight 108 within an elevator shaft 120 and along the guide rail 112.

The suspension element 108 engages the elevator machine 114, which is part of an overhead structure of the elevator system 102. The elevator machine 114 is configured to control movement between the elevator car 104 and the counterweight 108, and thus control the position of the elevator car 104 within the elevator shaft 120. The encoder 116 may be mounted on a fixed part 122 at the top of the elevator shaft 120, such as on a support or guide rail, and may be configured to provide position signals related to a position of the elevator car 104 within the elevator shaft 120. In other embodiments, the encoder 116 may be directly mounted to a moving component of the elevator machine 114, or may be located in other positions and/or configurations as known in the art. The encoder 116 can be any device or mechanism for monitoring a position of an elevator car and/or counterweight, as known in the art.

The controller 118 is configured to control the operation of the elevator system 102, and particularly the elevator car 104. For example, the controller 118 may provide drive signals to the elevator machine 114 to control the acceleration, deceleration, levelling, stopping, etc. of the elevator car 104. The controller 118 may also be configured to receive position signals from the encoder 116 or any other desired position reference device. When moving up or down within the elevator shaft 120 along guide rail 112, the elevator car 104 may stop at one or more landings as controlled by the controller 118. The controller 118 may be located and/or configured in any suitable location or position within the elevator system 101. In one embodiment, the controller 118 may be located remotely or in the cloud.

The elevator machine 114 may include a motor or similar driving mechanism. The elevator machine 114 may be configured to include an electrically driven motor. The power supply for the motor may be any power source, including a power grid, which, in combination with other components, is supplied to the motor. The elevator machine 114 may include a traction sheave that imparts force to suspension element 110 to move the elevator car 104 within elevator shaft 120.

The elevator car 104 comprises an elevator car enclosure 106 which defines a volume (not visible in this Figure) therein for receiving a load to be transported. The load may comprise any object suitable for transportation by an elevator car. For example, the object may comprise a human, an animal, and/or goods. The elevator car enclosure comprises an opening which is door-shaped (not visible in this Figure) which is closed by an elevator car door 124. The elevator car door 124 may comprise an automatic car door configured to be opened and closed when at respective landings in the elevator shaft 120.

The elevator car enclosure 106 is formed from single moulded body. The elevator car enclosure 106 may be formed from any suitable material, for example a polymeric material, e.g. plastic. The elevator car enclosure 106 comprises a plurality of side walls 126, a ceiling 128 and a floor 130, all of which are integrally formed as a single body. In the example shown in FIG. 1, the side walls 126, ceiling 128 and floor 130 all comprise corrugated portions 132 which allow the elevator car enclosure 106 to expand into the expanded configuration as illustrated in FIG. 1. Accordingly, as will be appreciated, as a result of the ability to expand provided by the corrugated portions 132, the elevator car enclosure 106 has a variable volume.

The corrugated portions 132 may be integrally formed as part of a moulding process. The corrugated portions 132 may have any suitable form that permits expansion and contraction of the elevator car enclosure 106. For example, the corrugated portions 132 need not necessarily comprise sharp ridges and grooves, as depicted in FIG. 1, and instead the corrugated portions may have a curved profile.

The elevator car enclosure 106 is supported by a support frame 134. As illustrated, the support frame 134 supports the floor 130 of the elevator car enclosure 106 and also passes around the side walls 126 and over the ceiling 128. Mounting of the support frame 134 may be facilitated by mounting features (not visible in this Figure) which are integrally provided with the elevator car enclosure 106. The support frame 134 comprises a plurality of guide shoes 136 which engage with the guide rail 112 and act to guide the elevator car 104 within the elevator shaft 120.

The elevator car enclosure 106 further comprises a plurality of support members 138, in the form of rods, which are arranged to hold the elevator car enclosure 106 in the expanded configuration shown in FIG. 1. As the elevator car enclosure 106 shown in FIG. 1 is capable of expanding and contracting in the horizontal plane, the plurality of support members extend in a horizontal direction.

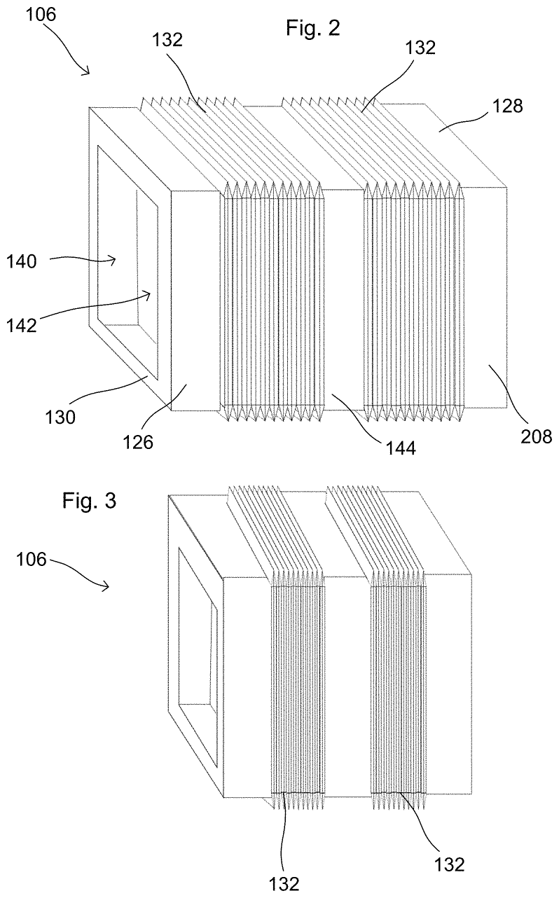

FIG. 2 shows a perspective view of the elevator car enclosure 106 in isolation from other parts of the elevator system 102. The elevator car enclosure 106, including the side walls 126, ceiling 128 and floor 130 is formed from a single moulded body. The corrugated portions 132 are also integrally formed as part of the single moulded body. As is visible in this Figure, the elevator car enclosure 106 comprises a door shaped opening 140 for allowing the passage of a load into, and out of, the volume 142 defined by the elevator car enclosure 106.

The elevator car enclosure 106 comprises a support frame mounting feature 144 arranged between the two corrugated portions 132. The support frame mounting feature 144 is dimensioned to mount the support frame 134 shown in FIG. 1, and ensures the proper positioning of the support frame 134 on the elevator car enclosure 106.

In FIG. 2, the elevator car enclosure 106 is shown in its expanded configuration. FIG. 3 illustrates the elevator car enclosure 106 in its contracted configuration. As will be appreciated by those skilled in the art, due to the arrangement of the corrugated portions 132, the elevator car enclosure 106 is able to expand and contract in the horizontal plane. The ability to expand and contract in this manner may advantageously make transport of the elevator car enclosure 106 to an installation site easier. In the contracted state, the elevator car enclosure 106 will take up less space and will thus require less space to transport. This may allow more elevator car enclosures 106 to be transported, or reduce the size of the vehicle required to transport the elevator car enclosure 106. Additionally, moving the elevator car enclosure 106 into position on site may also be easier in the contracted configuration shown in FIG. 3. Further, as discussed above, the ability to expand the elevator car enclosure 106 may allow the elevator car enclosure 106 to be expanded to the desired size on site. The elevator car enclosure 106 may thus be expanded to meet the size requirements of the particular elevator installation where it is being installed.

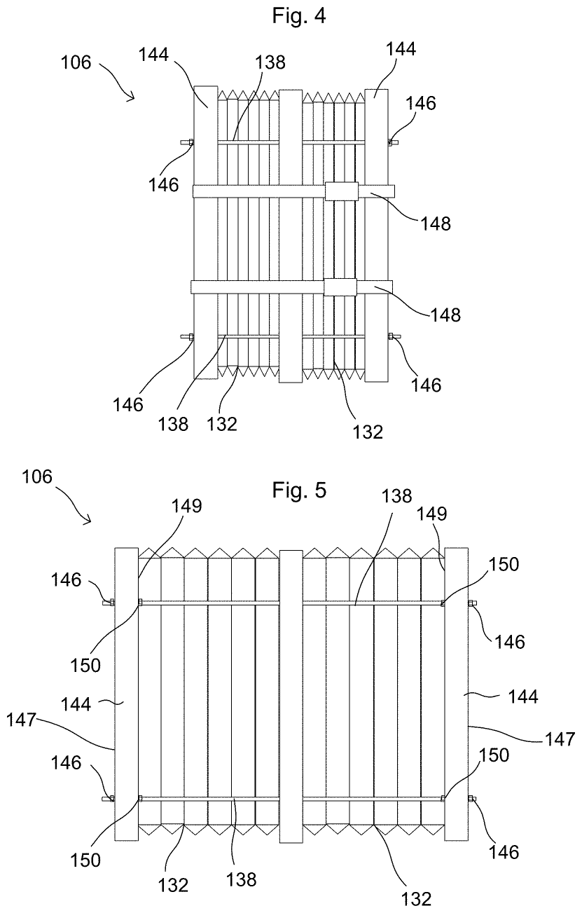

FIG. 4 shows a side view of the elevator car enclosure 106 in the contracted configuration. As depicted in this Figure, the corrugated portions 132 are compressed so that the elevator car enclosure 106 is in the contracted configuration. As the elevator car enclosure 106 may be manufactured from an at least partially resilient material, e.g. plastic, when in the compressed state shown in this Figure, the corrugated portions 132 tend to try to expand and thereby act to expand the elevator car enclosure 106 into an expanded configuration. As depicted, the support members 138 may act to hold the elevator car enclosure 106 in the contracted position. The support member 138 may pass through end portions 144 of the elevator car enclosure 106 and engage with locking members 146. The locking members 146 may, for example, comprise internally threaded nuts which engage with an external thread provided at least on the ends of each of the support members 138. As will be appreciated by those skilled in the art, the support members 138 and the locking members 146 may be capable of securing the elevator car enclosure 106 in the contracted configuration.

In addition or alternatively to the support members 138 and locking members 146, straps 148, e.g. in the form of ratchet straps, may be provided to secure the elevator car enclosure 106 in the contracted configuration. The straps 148 may be removed when it is desired to expand the elevator car enclosure into the expanded configuration.

FIG. 5 shows a side view of the elevator car enclosure 106 in the expanded configuration. This expanded configuration may be achieved by releasing the locking members 146 shown in FIG. 4, thus allowing the corrugated portions 132 to expand thus expanding the elevator car enclosure into the expanded configuration. The support member 138 shown in FIG. 4 may be extendable and thus may also act to support the elevator car enclosure 106 in the expanded configuration. Of course, a further, different support member may be used to support the elevator car enclosure in the expanded configuration. In the expanded configuration, locking members 146 may be secured to an outside face 147 of the end portions 144 and further locking members 150 may be secured to the support member 138 on an inside face 149 of the end portions 144. As will be appreciated, this arrangement may prevent the elevator car enclosure 106 from expanding or contracting.

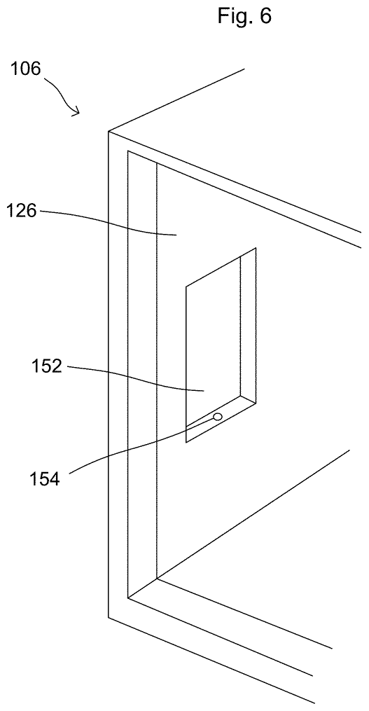

FIG. 6 shows a cutaway view of the elevator car enclosure 106. As depicted, the elevator car enclosure 106 comprises an integrally moulded car operating panel mounting feature 152 which is defined by a recess in the side wall 126. Additionally, the elevator car enclosure 106 comprises an integrally moulded conduit 154 for mounting at least one cable in the elevator car enclosure 106. For example, the conduit 154 may be for mounting a cable which is connected to a car operating panel mounted within the car operating panel mounting feature 152. Of course, the elevator car enclosure 106 may comprise any number of different mounting features. For example, the elevator car enclosure 106 may comprise mounting features for mounting lights, speakers, handrails or any other element within the elevator car.

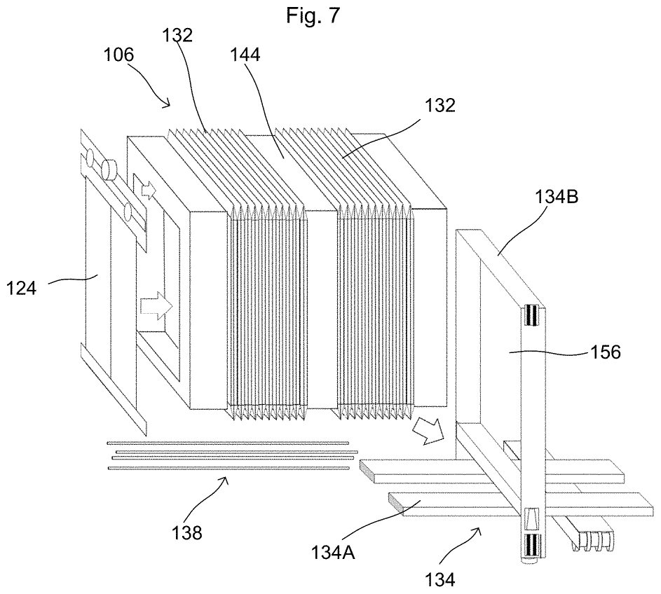

Assembly of the elevator car 104 shown in FIG. 1 will now be described with reference to FIG. 7. The elevator car enclosure 106 may be transported to a site and expanded from its contracted configuration into an expanded configuration in a size suitable for the particular elevator installation. This may be achieved, for example, by operators removing the locking members 146 or straps 148 shown in FIG. 4. The elevator car enclosure 106 may then expand automatically under the resilience provided by the corrugated portions 132. In addition or alternatively, installers may physically pull the elevator car enclosure 106 into the expanded state.

The elevator car enclosure 106 may then be inserted into the support frame 134. As can be seen in FIG. 7, the support frame 134 comprises a plurality of floor support members 134A as well as wall and ceiling support member 134B. The elevator car enclosure 106 may be flexible, e.g. due to the material from which it is made from and the corrugated portions 132, and thus it may be possible to push the elevator car enclosure into the opening 156 defined by the frame 134 so that the wall and ceiling support member 134B is mounted within the support frame mounting feature 144. The elevator car enclosure 106 may flex and change shape slightly as it is inserted into the frame 134. Of course, at least part of the support frame 134 may be disassembled and subsequently reassembled around the elevator car enclosure 106. The support members 138 may also be secured in place so as to hold the elevator car enclosure 106 in its expanded position. This may be performed before, or after, the elevator car enclosure has been inserted into the support frame 134.

The elevator car door 124 may be mounted to the elevator car enclosure 106 before, or after, the support frame 134 has been mounted to the elevator car enclosure 106.

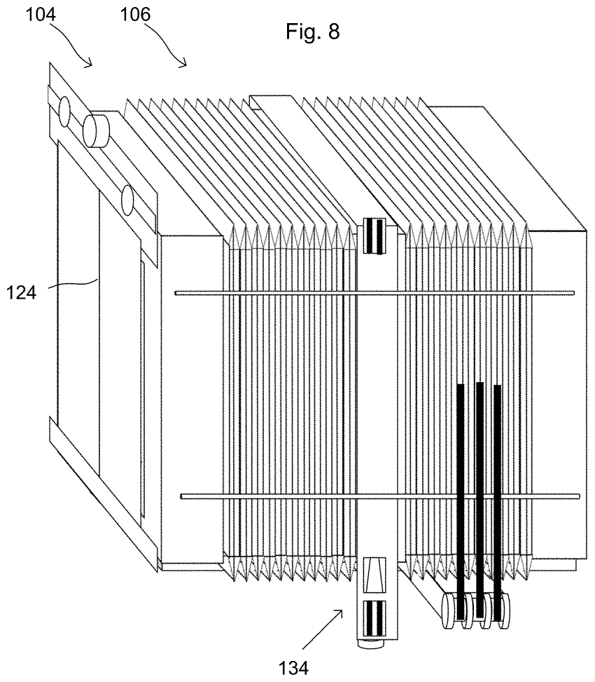

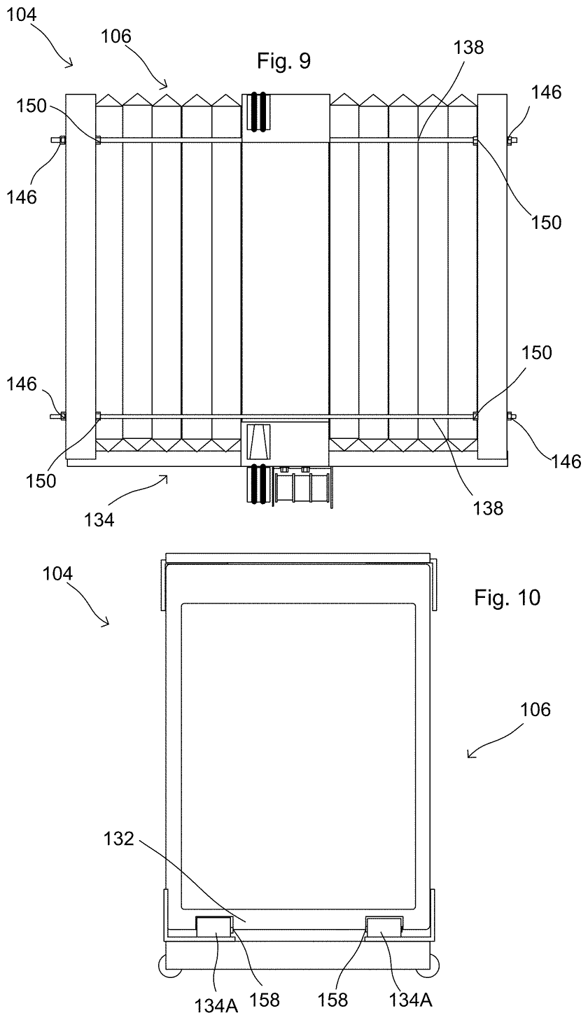

FIG. 8 shows the elevator car 104 in the fully assembled state, i.e. with the support frame 134 and the elevator car door 124 mounted to the elevator car enclosure 106 which is in the expanded configuration. FIG. 9 shows a side-on view of the elevator car 104 in the fully assembled state. As depicted, the support members 138, together with the locking members 146 and further locking members 150 hold the elevator car enclosure 106 in the expanded configuration even when the support frame 134 is attached thereto. Whilst not shown, the support frame 134 may also engage with the elevator car enclosure 106 in a manner which holds the elevator car enclosure in the expanded configuration.

FIG. 10 shows a front view of the elevator car 104, with the elevator car door 124 removed. As visible in this front view, the elevator car enclosure 106 comprises frame mounting features 158 integrally formed in the floor 132 of the elevator car enclosure 106. The frame mounting features 158 are shaped to receive the floor support members 134A. The frame mounting features 158 may ensure the proper mounting of the floor support members 134A, thus ensuring that the floor 132 is properly supported by the floor support members 134A.

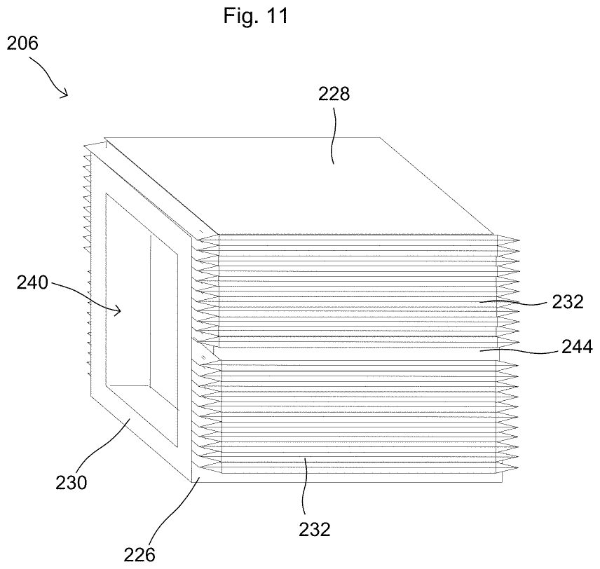

The elevator car enclosure 106 in the example described above is capable of expanding and contracting in the horizontal plane. The vertical dimension of the elevator car enclosure 106 is fixed and the horizontal dimension may be changed. However, in certain instances it may be desirable to be able to expand and/or contract the elevator car in the vertical direction. FIG. 11 illustrates an example of an elevator car enclosure 206 in accordance with another example of the present disclosure. The elevator car enclosure 206 is similar to the elevator car enclosure 106 described above, except that it is capable of expanding and contracting in a vertical plane. The elevator car enclosure 206 comprises a plurality of side walls 226, a ceiling 228 and a floor 230. In this example, all of the side walls 226 comprise corrugated portions 232, including the front and rear side walls 226. In this example, there are no corrugations on the ceiling 228 or on the floor 230 as these are not required in order to facilitate expansion in the vertical plane. As a result, the elevator car enclosure 206 is capable of expanding and contracting in a vertical plane, i.e. in a vertical direction. Similarly to the example described above, the elevator car enclosure comprises a door-shaped opening 240 and a mounting feature 244 which may mount a support frame.

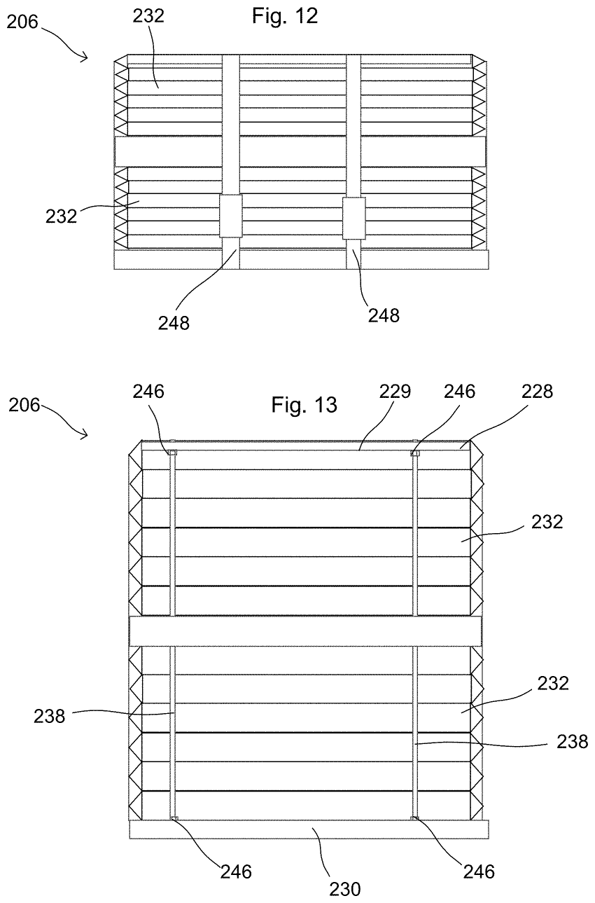

FIG. 12 shows a side view of the elevator car enclosure 206 in a contracted configuration. As depicted, in the contracted configuration the corrugations 232 are compressed. Support members in the form of straps 248, e.g. ratchet straps, may hold the elevator car enclosure in the contracted configuration. The straps 248 may be released to allow expansion of the elevator car enclosure from the contracted configuration into an expanded configuration.

FIG. 13 shows a side view of the elevator car enclosure 206 in an expanded configuration. As depicted, in this expanded configuration, in which the elevator car enclosure 206 has been expanded in the vertical plane, the elevator car enclosure 206 is held in the expanded configuration by support members 238. As the weight of the elevator car enclosure 206 may tend to pull it back towards its contracted configuration, it may only be necessary to prevent the elevator car enclosure 206 from contracting, and it may not be necessary to stop it from expanding as this may be resisted by gravity. In this regard, as depicted, the locking members 246 are attached to the support members 238 on an underside 229 of the ceiling 228 of the elevator car enclosure 246. The locking members 246 thereby bare against the underside 229 of the ceiling 228 and together with the support members 238 prevent the elevator car enclosure 206 from contracting, i.e. collapsing. As shown, the support members 238 extend into the floor 230 and are secured in place by locking members 246. The support members 238 may, for example, extend into apertures in the floor 230. As will be appreciated, the weight of the elevator car enclosure 106 bearing down on the support members 238 from the ceiling 228 may be sufficient to hold the support members 238 in place in the floor 230 and the locking members 246 provided at the floor 230 may be omitted.

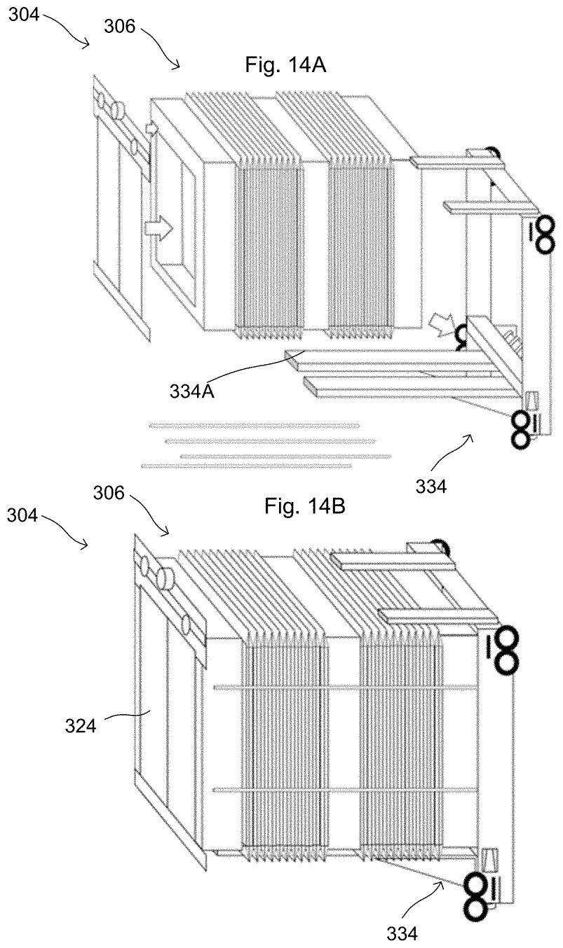

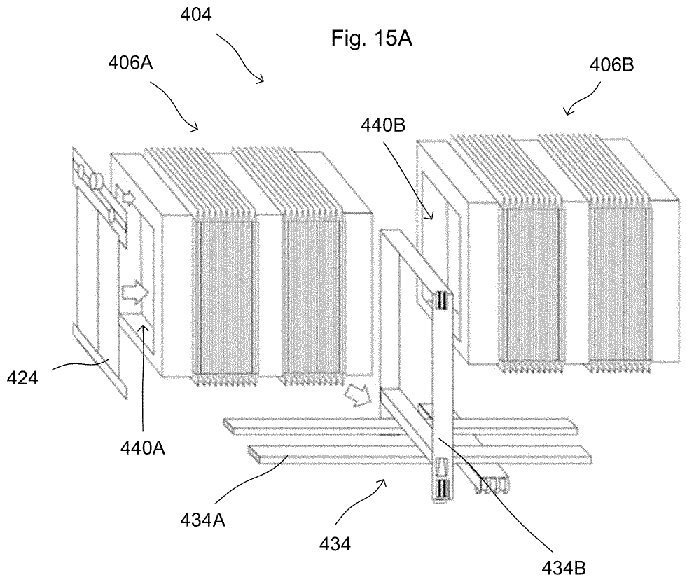

FIGS. 14A and 14B illustrate an elevator car 304 which comprises an elevator car enclosure 306 and a cantilever support frame 334. The elevator car enclosure 306 is the same as the elevator car enclosure 106 described above. FIG. 14A shows the elevator car 304 in a disassembled state and more clearly shows how the cantilever support frame 334 comprises a plurality of cantilever floor support members 334A. As will be appreciated, when the elevator car enclosure 306 is mounted to the frame, the cantilever floor support members 334A act to support an underside, i.e. the floor, of the elevator car enclosure 306. FIG. 14B shows the elevator car in an assembled state with the elevator car enclosure 306 mounted to the cantilever support frame 334, and with the door assembly 324 attached to the elevator car enclosure 306. The elevator car 304 comprising a cantilever support frame 334 may be particularly well suited for use in elevator hoistways which only have a single wall to which the elevator car 304 can be mounted.

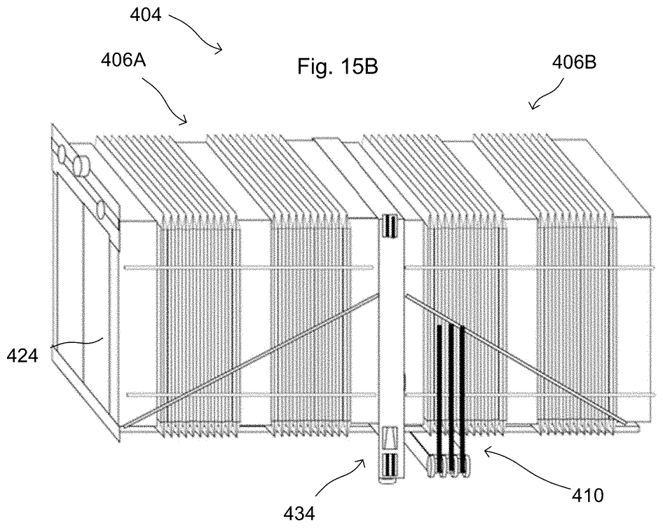

Whilst in the various examples described above, the elevator car comprises a single elevator car enclosure, the elevator car may comprise a plurality of elevator car enclosures which may be connected together in a modular manner. FIG. 15A illustrates a view of another example of an elevator car 404 in a disassembled state. As shown, the elevator car 404 comprises a first elevator car enclosure 406A and a second elevator car enclosure 406B. The second elevator car enclosure 406B is the same as the elevator car enclosure 106 described above, and the first elevator car enclosure 406A is the same as the elevator car enclosure 106 described above, except that it has an additional opening at its rear.

The support frame 434 comprises support members 434A, which extend to both sides of a central frame 434B, so as to be capable of supporting each of the first and second elevator car enclosures 406A, 406B. The first elevator car enclosure 406A comprises a forward opening 440A at its forward end and a rearward opening at its rearward end (not visible in this Figure). The second elevator car enclosure 406B comprises a single opening 440B. When assembled, the rearward opening on the rearward end of the first elevator car enclosure 406A is coupled to the opening 440B on the second elevator car enclosure 406B and thus allows a load to pass between each of the first and second elevator car enclosures 406A, 406B. The forward opening 440A on the first elevator car enclosure is closed by a door assembly 424.

FIG. 15B shows the elevator car 404 in a fully assembled state. As shown, the first and second elevator car enclosures 406A, 406B are mounted to the support frame 434 and the door assembly 424 is mounted to the first elevator car enclosure 406A to selectively close the forward opening 440A (not visible in this Figure). In the example shown in FIG. 15B, a single suspension element 410 is provided to raise and lower the elevator car 404. The suspension element 410 may comprise any number of suitable tension members, e.g. ropes, cables or steel belts. The volume of each of the first and second elevator car enclosures 406A, 406B couple together to form a single, combined, larger volume. The elevator car 404 thus has an increased volume and may be capable of carrying an increased load. The elevator car 404 may be capable of carrying an increased load, e.g. an increased number of objects and/or carrying larger or heavier objects.

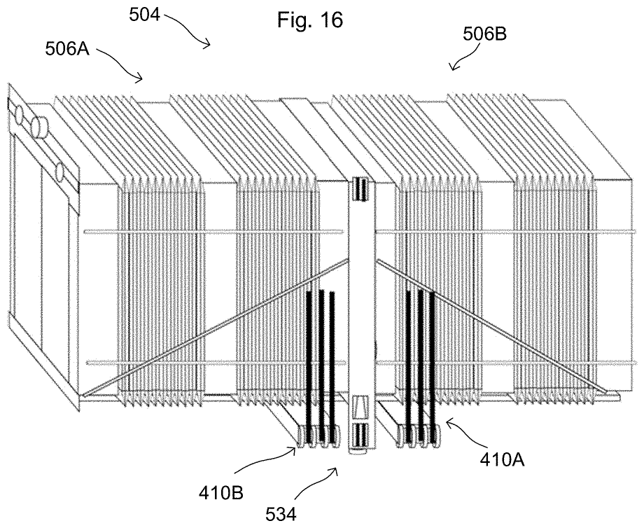

In some examples, particularly in those where the elevator car comprises multiple elevator car enclosures, the elevator car may be capable of transporting a heavier load. Accordingly, it may be necessary to provide additional suspension elements to support the weight of the elevator car and any load therein. FIG. 16 shows another example of an elevator car 504 comprising a first elevator car enclosure 506A and a second elevator car enclosure 506B supported by a support frame 534. The first and second elevator car enclosures 506A, 506B may be coupled together by any suitable means. As shown in FIG. 16, the elevator car 504 comprises a first suspension element 410A and a second suspension element 410B. The first and second suspension elements 410A, 410B may allow the elevator car 504 to transport heavier loads.

It will be appreciated that any number of elevator car enclosures may be coupled together to form a larger overall elevator car enclosure. Each of the elevator car enclosures may have any number of suitable openings which allow the passage of a load from one elevator car enclosure to an adjacent elevator car enclosure, as well as openings which allow a load to pass from an elevator car enclosure to another part of the elevator system, e.g. a landing thereof.

Whilst not depicted in the examples above, the elevator car enclosures may be capable of expansion and contraction in both horizontal and vertical planes. In this regard, the elevator car enclosure may comprise corrugations that facilitate such expansion. For example, corrugations may be provided on all of the walls of the elevator car enclosure, as well as on the ceiling and floor thereof. Further, whilst the examples described above include a floor and a ceiling, this is not essential and the elevator car enclosure may, for example, be devoid of a ceiling.

Accordingly, it will be appreciated by those skilled in the art that examples of the present disclosure provide an improved elevator car enclosure which is formed from a single moulded body, as well as an elevator car comprising such an elevator car enclosure. While specific examples of the disclosure have been described in detail, it will be appreciated by those skilled in the art that the examples described in detail are not limiting on the scope of the disclosure.

What is claimed is:

1. An elevator car enclosure (106, 206, 306, 406A; 406B, 506A; 506B) which defines a volume (142) for receiving a load to be transported, wherein the elevator car enclosure (106, 206, 306, 406A; 406B, 506A; 506B) is formed from a single moulded body.

2. The elevator car enclosure (106, 206, 306, 406A; 406B, 506A; 506B) as claimed in claim 1, wherein the single moulded body comprises a polymeric material.

3. The elevator car enclosure (106, 206, 306, 406A; 406B, 506A; 506B) as claimed in claim 1, wherein the elevator car enclosure (106, 206, 306, 406A; 406B, 506A; 506B) has a variable volume (142).

4. The elevator car enclosure (106, 206, 306, 406A; 406B, 506A; 506B) as claimed in claim 3, configured to be capable of expanding from a contracted configuration, in which the elevator car enclosure (106, 206, 306, 406A; 406B, 506A; 506B) has a first volume, into an expanded configuration in which the elevator car enclosure (106, 206, 306, 406A; 406B, 506A; 506B) has a second, larger volume.

5. The elevator car enclosure (106, 206, 306, 406A; 406B, 506A; 506B) as claimed in claim 4, comprising a plurality of walls (126; 128; 130, 226; 228; 230) which define the volume (142) and wherein at least one of the plurality of walls (126; 128; 130, 226; 228; 230) comprise a corrugated structure (132, 232) configured to allow the elevator car enclosure (106, 206, 306, 406A; 406B, 506A; 506B) to expand from the contracted configuration into the expanded configuration.

6. The elevator car enclosure (106, 206, 306, 406A; 406B, 506A; 506B) as claimed in claim 4, wherein the elevator car enclosure (106, 206, 306, 406A; 406B, 506A; 506B) is configured to be capable of expanding in a horizontal plane and/or a vertical plane.

7. The elevator car (106, 206, 306, 406A; 406B, 506A; 506B) enclosure as claimed in claim 4, further comprising at least one support member (138; 148, 248) arranged to hold the elevator car enclosure in the contracted configuration.

8. The elevator car enclosure (106, 206, 306, 406A; 406B, 506A; 506B) as claimed in claim 1, further comprising at least one support member (138, 238) arranged to hold the elevator car enclosure (106, 206, 306, 406A; 406B, 506A; 506B) in the expanded configuration.

9. The elevator car enclosure (106, 206, 306, 406A; 406B, 506A; 506B) as claimed in claim 1, wherein the single moulded body comprises at least one integrally formed mounting feature (144; 152; 154; 158, 244) for mounting an elevator car component to the elevator car enclosure (106, 206, 306, 406A; 406B, 506A; 506B).

10. The elevator car enclosure (106, 206, 306, 406A; 406B, 506A; 506B) as claimed in claim 1, wherein the single moulded body comprises an opening (140, 240) for allowing the passage of a load into the volume (142) defined by the single moulded body.

11. The elevator car enclosure (106, 206, 306, 406A; 406B, 506A; 506B) as claimed in claim 1, wherein the single moulded body comprises a plurality of side walls (126, 226) which at least partially define the volume (142) of the elevator car enclosure (106, 206, 306, 406A; 406B, 506A; 506B).

12. The elevator car enclosure (106, 206, 306, 406A; 406B, 506A; 506B) as claimed in claim 1, wherein the single moulded body comprises a floor (130, 230) and/or a ceiling (128, 228) which at least partially define the volume (142) of the elevator car enclosure (106, 206, 306, 406A; 406B, 506A; 506B).

13. An elevator car comprising:
one or more of the elevator car enclosures according to claim 1; and
a frame configured to support the one or more elevator car enclosures.

14. A method of assembling an elevator car (104, 304, 404, 504, 604) comprising a support frame (134, 334, 434, 534, 634) and an elevator car enclosure (106, 206, 306, 406A; 406B, 506A; 506B) which defines a volume (142) and which is formed from a single moulded body, wherein the method comprises attaching the support frame (134, 334, 434, 534, 634) to the elevator car enclosure (106, 206, 306, 406A; 406B, 506A; 506B) to form the elevator car (104, 304, 404, 504, 604).

15. The method as claimed in claim 14, wherein the elevator car enclosure (106 206, 306, 406A; 406B, 506A; 506B) has a variable volume (142) and wherein the method comprises changing the volume (142) of the elevator car enclosure (106 206, 306, 406A; 406B, 506A; 506B) to a desired volume at an elevator installation site.
